(19) United States
(12) Patent Application Publication
(10) Pub. No.: US 2005/0028001 A1
(43) Pub. Date: Feb. 3, 2005

(54) Secured software patching and upgrade method for densely deployed networks having spanning-tree topology

(76) Inventors: Jian Huang, Coral Springs, FL (US); Chin Pan Wong, Coral Spring, FL (US); Jianping Miller, Coral Springs, FL (US)

Correspondence Address: LERNER AND GREENBERG, PA, P O BOX 2480, HOLLYWOOD, FL, 33022-2480, US

(21) Appl. No.: 10/629,104

(22) Filed: Jul. 29, 2003

(51) Int. Cl. H04L 9/00

(52) U.S. Cl. 713/200; 717/168

(57) ABSTRACT

A method for secured software patching and upgrade in a distributed wireless sensor network (DSN) includes the steps of providing a spanning-tree network of communications nodes with at least one root node (CH) and at least one software upgrade repository (SR), receiving a software upgrade with the root node (CH), communicating the upgrade from the root node (CH) to the software upgrade repository (SR), and installing the upgrade from the software upgrade repository (SR) to all of the nodes on the same branch by authenticating a patch key and delivering the upgrade from the software upgrade repository (SR) to the nodes after authentication occurs. The communications nodes (1000) can be sensor devices each sensing, processing, transmitting, receiving, and actuating in a given geographical area.

### BACKGROUND OF THE INVENTION

1. Field of the Invention

The invention lies in the field of electronic communications. The invention relates to a secured software patching and upgrade method for densely deployed networks having spanning-tree topology.

A Distributed Sensor Network (“DSN”) is made up of many independent sensing devices disposed in a given environment, each of the sensing devices being capable of sensing, processing, transmitting, receiving, and actuating within a given communications range. Accordingly, the sum of all of the communications ranges makes up a coverage area of the DSN. The basic function of the DSN is to detect one or more events occurring randomly in the environment within the coverage area. Based upon such detection, a decision can be derived and resulting action can be applied in a timely manner according to predefined requirements or other criteria. Due to the dynamic nature of the environment, it is desirable to place many sensing devices within the environment.

One of the critical components in constructing such a densely deployed device network is the control of a software upgrade and patch mechanism that enables the system to be immune to unauthorized intrusion. If a pure centralized authentication approach were applied, the communications overhead would increase in an undesirable manner and make the server of such a network be a single point for overall network failure. It would, therefore, be desirable to provide an upgrade and patch mechanism that is not based only upon a centralized authentication approach. The system resources including computing capability and power on those devices in a DSN are assumed to be limited. Thus, it is unrealistic to offer network-wide authentication of long public keys.

2. Description of the Related Art

Densely deployed wireless sensor networks have received a lot of attention due to their potential applications in exploration, in emergencies, and in battlefields. Network security is, therefore, one of the significant concerns. The constraints imposed by the limited system resources residing on those small sensor devices present challenges in direct applications of cryptographic technologies widely used at the present time in the Internet. A number of state-of-the-art techniques have been reviewed by Roberto Di Pietro, Yee Wei Law, Sandro Etalle, Pieter H. Hartel, and Paul Havinga in “State of the Art in Security of Wireless Sensor Networks,” Sep. 4, 2002, and by Yee Wei Law, Sandro Etalle, and Pieter Hartel in “Key Management with Group-Wise Pre-Deployed Keying and Secret Sharing Pre-Deployed Keying,” Jul. 16, 2002.

To carry out software patching and upgrade over the air in a secured fashion, a scalable method for key deployment and key management scheme must be in place. The design of a key establishment scheme protocol can fall into one of the three categories: centralized, sub-group distributed, and completely distributed. See, i.e., Di Pietro et al., “State of the Art in Security of Wireless Sensor Networks,” Sep. 4, 2002. Specifically relevant to the process of a software patching and upgrade procedure is that the software repositories have to be defined.

### SUMMARY OF THE INVENTION

The invention provides a secured software patching and upgrade method for densely deployed networks having spanning-tree topology that overcomes the hereinafore-mentioned disadvantages of the heretofore-known devices and methods of this general type and that is resilient to attack and enables securing software updating in a distributed sensor network with a spanning-tree topology.

The approach to the key establishment and software patching/upgrade according to the present invention is based on the considerations of topological dependency and, especially, upon the positions of a software repository and its replicas. Also, the present invention takes into consideration the trade-off between a level of security and a length of the keys. A logical topology of the distributed wireless sensor network is assumed in the present invention to be a spanning-tree structure with a root at a node receiving the software upgrade/patch. This node often services as a gateway to other types of networks such as the Internet. The immediate neighbors of the root node, i.e., its children, are defined in the present invention as software upgrade/patch repositories (SR). The root node is responsible for deploying and managing keys of the SRs with a desirable key length defined by the root node. Each SR serves as a subgroup controller and is responsible for new key deployment and management for all of the nodes underneath the respective SR on the same branch of the spanning tree. The choice of the key length does not have to be the same on each branch of the spanning-tree. Considering a software upgrade/patching process on a portion of all of the branches, the key length may be different from a length used when the process occurs on all of the branches. The approach according to the present invention can be considered as a hybrid of a centralized scheme and a subgroup distributed scheme, as defined in Di Pietro et al., “State of the Art in Security of Wireless Sensor Networks,” Sep. 4, 2002.

Other features that are considered as characteristic for the invention are set forth in the appended claims.

Although the invention is illustrated and described herein as embodied in a secured software patching and upgrade method for densely deployed networks having spanning-tree topology, it is, nevertheless, not intended to be limited to the details shown because various modifications and structural changes may be made therein without departing from the spirit of the invention and within the scope and range of equivalents of the claims.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a diagrammatic representation of a network of sensing devices forming a spanning-tree structure;

FIG. 2 is a flow chart of the overall upgrade/patch method according to the invention in an exemplary embodiment for a wireless device;

FIG. 3 is a diagrammatic illustration of a data packet used by the method according to the invention for a wireless device;

FIG. 4 is a flow chart of the updating/patching method according to the invention in an exemplary embodiment for a wireless device;

FIG. 5 is a diagrammatic illustration of lines of software code to be updated;

FIG. 6 is a diagrammatic illustration of an updated version of the lines of software code of FIG. 5;

FIG. 7 is a diagrammatic illustration of an updated version of the lines of software code of FIG. 5 with a new intermediately added line;

FIG. 8 is a diagrammatic illustration of an updated version of the lines of software code of FIG. 5 without an intermediately added line;

FIG. 9 is a diagrammatic illustration of a patch of additional lines of software code to the code of FIG. 8; and

FIG. 10 is a block circuit diagram of a node according to the invention.

### DESCRIPTION OF THE PREFERRED EMBODIMENTS

While the specification concludes with claims defining the features of the invention that are regarded as novel, it is believed that the invention will be better understood from a consideration of the following description in conjunction with the drawing figures, in which like reference numerals are carried forward.

The present invention provides a secured software patching and upgrade method for densely deployed networks having spanning-tree topology with a distributed access control and session-based, dynamic group membership.

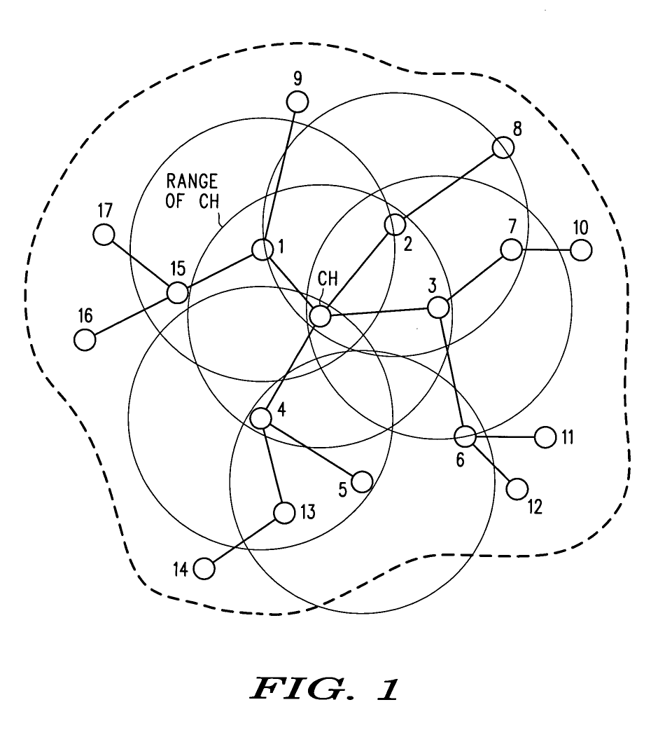

The basic configuration of the DSN includes a large number of sensor devices, each having functionality for sensing, processing, transmitting, receiving, and actuating, covering a given geographical area. It is assumed that all of the sensor devices have an equal transmission range and have the ability to form a spanning-tree structure. An example of such a structure is illustrated in FIG. 1.

The network depicted in FIG. 1 is assumed to be a regular graph in which the node degree, the number of edges, or the difference among the number of neighbors for all of the nodes (also referred to as a vertex) are not spread to a wide range. The branching factor is, therefore, not large and, for simplicity, is assumed to be less than 6 to avoid any interference between adjacent branches in a software patching process. The branching factor is determined by the number of branches extending off a root node, also referred to as a cluster head CH. In the example described with regard to FIG. 1, the branching factor is 4. The example of FIG. 1 is referred to as a quad-tree because four branches extend from the cluster head CH.

Normally, there are two separate components in the procedure of providing an upgrade/patch: (1) authentication and (2) patch delivery and installation. To avoid long public keys, the present invention offers a flexible structure with variable-length public keys having a shorter length for the leaf nodes (the nodes farther away from the controller CH) and a longer length for the higher-level nodes. The present invention provides an example of a two-byte public key deployment protocol deployed on a spanning-tree (see FIG. 1). Because the present invention focuses on spanning-tree topology with the software depositories SR defined to be the immediate children of the root node (the nodes 1, 2, 3, 4 in FIG. 1, for example), the SR are the key managers, which are, in turn, managed by the root node. Therefore, the root nodes have the flexibility to allow those SRs to have two sets of keys, a first key set being used for the communications between and among the SRs and the root node and a second key set being used for the communications between each SR and its children. The lengths of the first set can be different from the second key set. Considering a software upgrade/patching procedure, an active branch may have different key length from inactive ones.

According to the present invention, the network is defined to have one software upgrade/patch repository SR for each branch. An original software upgrade/patch repository SR can be the root device CH or can be another device that communicates with the root device CH. If a software upgrade/patch is to be transmitted to each of the four branches, it is not necessary to conduct four separate updates because some of the branches are separated from one another in a way that will not prevent simultaneous or parallel updates. Specifically, the branches 1 and 3 are approximately opposite one another and the branches 2 and 4 are approximately opposite one another. It is noted that the four branches off of the cluster head CH in FIG. 1 are referred to herein by the number associated with the first node away from the cluster head CH.

Because each of the opposing sets of branches extending towards opposite directions will not interfere with one another's communications, the software upgrade/patches processes are orthogonal and, therefore, can and will, preferably, be executed in parallel within the same upgrade/patch session. Specifically, a first upgrade/patch session will be conducted for the branches 1 and 3 and a second upgrade/patch session will be conducted for the branches 2 and 4 (first and second not necessarily indicating a preferential order).

Authentication and successful acknowledgement messages can be controlled by patch keys generated locally on each node, for example, according to the Diffie-Hellman (“DH”) method, which is described in U.S. Pat. No. 4,200,770 to Hellman et al., for example.

Under the DH method, three items are needed to produce a public key: a key length, a secret key (exponent), and a prime modulus. According to the present invention, a patch key is defined as a public key in the original DH algorithm and is generated locally based on a pre-defined key length, the secret key, and a prime modulus. A session key is defined as the public key generated on a software repository SR through the DH algorithm by substituting the patch key received from a node in place of the secret key.

Therefore, to obtain a patch key on all nodes according to the present invention, the DH algorithm input function is INPUT(key length+1, secret key, prime modulus). To obtain the session key on the software repositories SR, the DH algorithm input function is INPUT(key length+1, patch key, prime modulus).

Accordingly, before any upgrade/patch is conducted, the session key, the patch key, and the prime modulus are exchanged between the two nodes undertaking the upgrade/patch. A patch key is generated and stored in both the local node (client) and the key server (here, the SR). If the SR finds no conflict among the patch keys it maintains, then it will offer a session key to the local node (client). The session key along with the prime modulus is shared by all of the nodes in all orthogonal upgrade/patch processes but is defined and maintained by the SR.

It is self-evident that larger patch keys require more processing and system resources (i.e., memory). Therefore, it is desirable to have a short or variable length of patch key for this spanning tree network in order to reduce or minimize the amount of processing required and resources necessary. The invention according to the present invention provides a very short-length patch key as set forth below.

The pair of the software upgrade/patch repositories SR on the branches with orthogonal updating processes running in parallel (1-3 or 2-4) can share a respective session key. The nodes in the same session form a group with a unique group identification or session key determined by the SR. The software upgrade/patch procedure starts from the SR along the branch and eventually reaches all of the leaf nodes. In every step along the branch, on each node in the same session, a simple two-byte patch key is generated with the DH method.

An example explaining how the keys are generated and the exchange of patch key and prime modulus works is set forth in the following text.

Considering the branch 3 in FIG. 1 having nodes 3, 6, 7, 10, 11, and 12, the node 3 is the SR. Thus, to start the upgrade/patch process on nodes 6 and 7 and, then, on nodes 10, 11, and 12, the SR 3, first, generates a patch key using a secret key (9A2E hexadecimal) and a predefined prime modulus (10001 hexadecimal). The SR 3, then, executes the DH algorithm: DH(3 9A2E 10001), where DH is an executable function with input parameters of a key length of 2 plus 1 bytes, the secret key, and the prime modulus (10001 hexadecimal). The result is a patch key of 3C66 hexadecimal. All three of the numbers corresponding to the key length, the patch key, and the prime modulus, then, will be sent to the node 6. On the node 6, a random secret key is picked, 4C20 hexadecimal, for example. Then, the node 6 executes the same DH algorithm as: DH (3 4C20 10001) to generate its own patch key, which is 6246 hexadecimal, and sends this patch key back to the SR 3. The correct reception of a unique patch key from the target node 6 is the necessary condition for the SR (node 3) to authenticate a session key back to the node 6. Upon receiving the patch key 6246 from the node 6, the SR 3 runs the DH algorithm again with DH (3 6246 10001) to generate session key K, which is DED4.

When the node 6 receives the session key K, it is authenticated to proceed and the upgrade/patch procedure starts on the node 6. Therefore, the node 6 has to acknowledge that it receives the session key K but not necessarily in this round of communication. The SR 3 can, then, send an invitation message with the software version number L to the node 6. When receiving the software version number L correctly, the node 6 accepts the invitation and sends an acknowledge message back to the SR 3. The message contains L, K, and the node identification. As such, the session key K combined with a software version number L and the node identification can, then, be used to define the acknowledgement message from whoever is the recipient of the upgrade.

The same procedure can be repeated between the node 6 and the nodes 11 and 12, the nodes 3 and 7 and 7 and 10, the nodes CH and 1, 1 and 9, 1 and 15, and the node 15 and the nodes 16 and 17 to cover all of the nodes in the orthogonal processes running on the branches 1 and 3 and, then, can be run on the branches 2 and 4 in a similar way, but with a different session key. It is noted that the session key on other branches may or may not necessarily be the same.

The software upgrade/patch procedure according to the present invention can be applied to wireless devices in a two-step procedure:
(1) download the software patch/upgrade when the device is in operation mode and authenticated with the two-byte session key; and
(2) install software patch/upgrade after a reset.

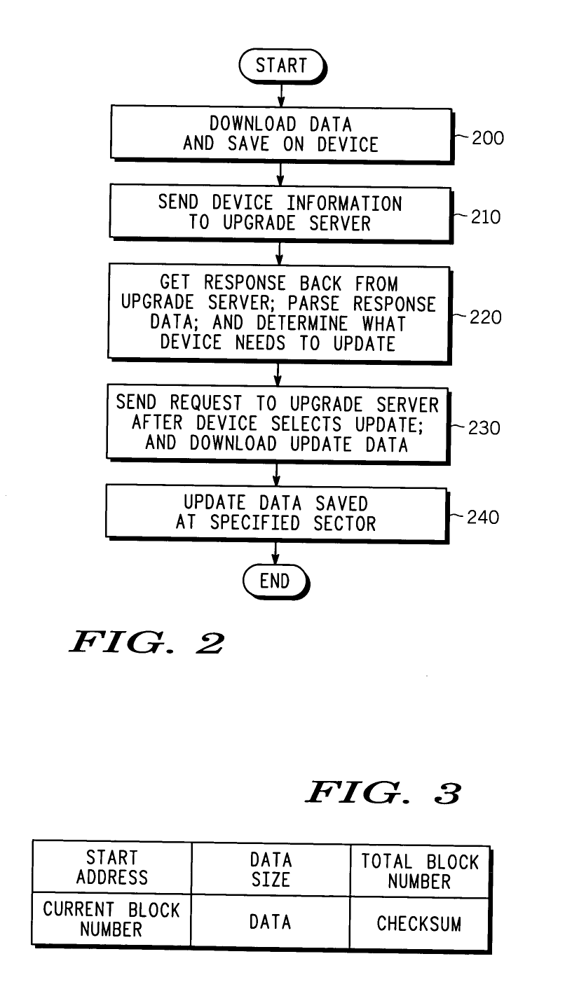

An example of the upgrade/patch procedure between two wireless devices is described with the flow charts and illustrations of FIGS. 2 to 9. The description of the over-the-air patching procedure involves three components: (1) indication of the location of the new program in static memory (defined as temporary flash, for example); (2) identifying the location of the old program (destination addresses); and
(3) utilizing random access memory (RAM) to execute the swap processes.

First, in Step 200, initial data (which at least includes the new software or patch) is downloaded and saved on a given wireless device in the network. It is assumed that this wireless device needs to be updated with a patch. Therefore, in Step 210, information regarding present characteristics of the device is sent from the device to the upgrade server, preferably, through packet data, so that the server can determine whether or not a patch/upgrade needs to be performed. This information can include, for example, a serial number, a patch version, and a configuration version. The server can be any other wireless device in the network that can transfer the update/patch including the actual server of the network.

In Step 220, the device receives a response back from the upgrade server and parses the responsive data to determine what the aspects of the device needs to be updated or changed.

After the device selects the appropriate update, in Step 230 the device sends a request to the upgrade server and downloads the relevant data for the requested update. Preferably, if the data is in packet format, the data has a structure in a form shown in FIG. 3 (not necessarily in the order shown), which includes general characteristics used when communicating in a packet format, for example, a Start Address, a Current Block Number, Data Size, the Data relevant for the update to be performed as set forth above, a Total Block Number, and a Checksum.

In Step 240, the device saves the data at a specified sector of flash memory (a stable location that is typically used for wireless device software), for example, in the device. This sector is referred to herein as a temporary storage sector, which is the sector defined for storing the data downloaded from the upgrade server.

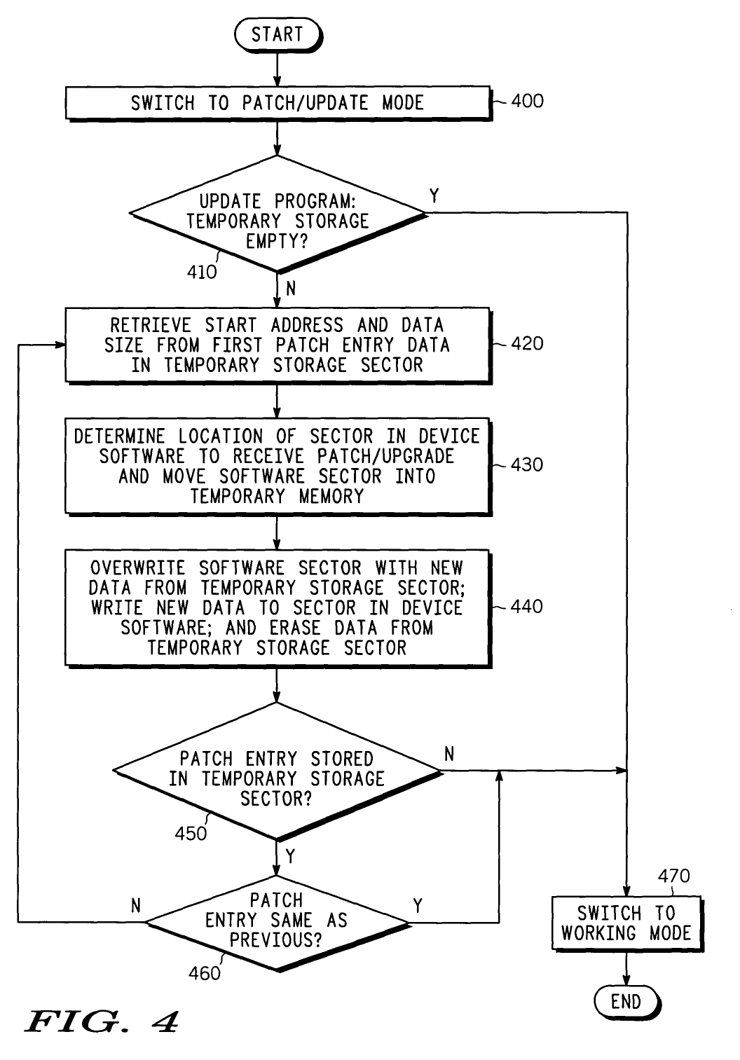

Updating of the device is explained with regard to FIG. 4.

Immediately after the device's power is turned on (or at any other particular time selected by the system, the network, or a user), the device switches to an update mode in Step 400 and, in Step 410, begins to run a special program, which is referred to herein as an UPDATE program. The UPDATE program first determines whether or not the temporary storage sector is empty. If the temporary storage sector is empty, then the device assumes that there is no update/patch to be performed and, therefore, the UPDATE program ends and the device is returned to a working mode. It is assumed herein that the process described above with respect to FIG. 2 is executed prior to executing the UPDATE program to allow for the possibility of filling up the temporary storage sector with an update/patch.

If the temporary storage sector is not empty, then, in Step 420, the UPDATE program retrieves the Start Address and Data Size from the Data in the temporary storage sector. See FIG. 3. In Step 430, the destination sector number in the software of the device for the patch/upgrade and the Data Size are found from the Data in the temporary storage sector and all data from that destination sector in the software is copied to the temporary memory in the device, preferably, in RAM because the patch of the destination sector number, at this point, is not complete and the software still needs to be updated. Simply put, the location and size of the patch/upgrade are found with these variables to assist in determining an area in RAM that will fit the patch/upgrade before being updated and re-loaded into the more permanent memory of the device. If the Data in the temporary storage sector will entirely replace a portion of the destination sector in the software of the device, then it is not necessary to copy first the data from the destination sector into RAM.

In Step 440, the data section of the destination sector in the software of the device is overwritten with the new Data from the temporary storage sector. In a preferred embodiment, the portion of the software in the destination sector residing in the more permanent flash memory of the device is stored in a temporary memory, such as RAM, the Data is copied from the temporary storage sector (residing in another portion of the RAM) over the software portion, and, finally, the updated software portion is written into the flash memory for long use storage. Because the patch entry is complete, this patch entry is, preferably, erased from the temporary storage sector. At this point, the temporary storage sector can be empty or can still contain another patch entry.

Therefore, in Step 450, the device determines if there is a patch entry stored in the temporary storage sector, and, if a patch entry is found, the Start Address and Data Size of the upgrade/patch is obtained by the device.

A non-repetition inquiry is, then, made in Step 460 to determine if the patch entry belongs to the same destination sector as the last patch entry, in other words, whether or not the patch entry the same one that has already been incorporated into the software of the device.

If the next patch entry does belong to the same destination sector, then it is assumed that the update program is finished and can end. Alternatively, a loop can be performed to continuously or repetitively search for a new patch entry that is different from the last patch entry already downloaded if new patch entries are updated in real-time, for example.

If the next patch entry does not belong to the same destination sector of the last patch entry, then it is assumed a new, different patch entry exists that needs to be downloaded and applied. Thus, Steps 420 to 460 are repeated until all subsequent patch entries are entered.

When all patch entries are entered or if the UPDATE program ends for another reason, in Step 470, the device is switched to a working mode—defined as a mode that is not the patch/update mode.

The following text includes two examples of a patch/update that can be made according to the present invention.

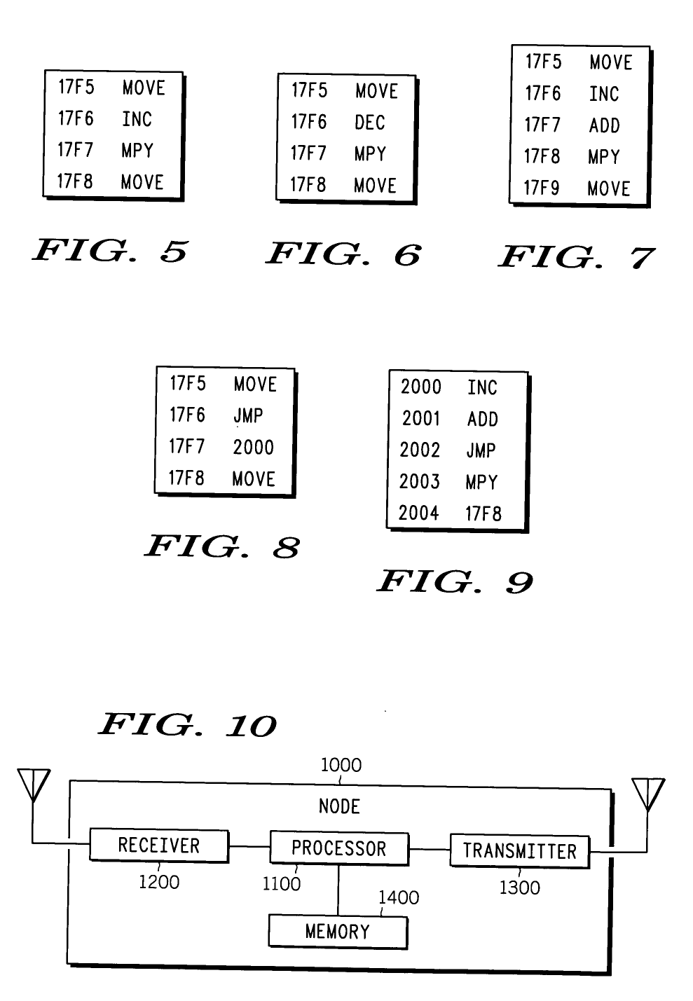

FIGS. 5 and 6 illustrate a simplified portion of a destination sector of a sector in the device software that is to be updated. FIG. 5 shows four example lines of code. In this example, the instruction at line 17F6 needs to be changed from an increment instruction “INC” to a decrement instruction “DEC.” Therefore, according to the method illustrated in FIG. 4, it is assumed that the temporary storage sector is not empty.

Then, in Step 420, the UPDATE program retrieves the Start Address and Data Size from the Data in the temporary storage sector. These two values correspond to 17F5 and 4, respectively, “4” being the number of lines of the sector to be copied from the device software. In Step 430, the destination sector number in the software of the device for the patch/upgrade and Data Size are found from the Data in the temporary storage sector and all data from that destination sector in the software is copied to the temporary memory. Specifically, lines 17F5 through 17F8 are copied from the sector in the device software.

This data section is overwritten in Step 440 with the new Data from the temporary storage sector illustrated in FIG. 6. Finally, the updated software is written into the flash memory for long use storage. Because the patch entry is complete, this patch entry is erased from the temporary storage sector. At this point, the temporary storage sector is assumed to be empty and, therefore, the inquiry in Step 450 is negative and the device is returned to its working mode in step 470.

A second example patch requires the insertion of an addition instruction “ADD” into the sector of device software illustrated in FIG. 5. The solution to such an example is illustrated with regard to FIGS. 5 and 7 to 9.

It is assumed that lines 17F9 and thereafter are already filled with software code and, therefore, it is desirable not to change this code if possible. However, if an addition instruction were inserted at line 17F7, as shown in FIG. 7, then line 17F9 would be written over impermissibly. To solve this problem, a patch having two parts is entered in the software. The first part is a replacement for lines 17F5 through 17F8. As shown in FIG. 8, lines 17F6 and 17F7 are replaced with a jump command indicating that the next line of code should be executed from line 2000. FIG. 9 illustrates the code that is to be added somewhere in a free space within the device software. It is assumed that lines 2000 to 2004 in the software code are free or are new and, therefore, these lines include the retained “INC” command, the new “ADD” command, the retained “MPY” variable, and a command to return to line 17F8, which contains the “MOVE” command.

Update of this two-part patch is performed according to the method of FIG. 4 as set forth in the following text.

It is assumed that the temporary storage sector is not empty and, therefore, in Step 420, the UPDATE program retrieves the Start Address and Data Size from the Data in the temporary storage sector. These two values correspond to 17F5 and 4, respectively, “4” being the number of lines of the sector to be copied from the device software. In Step 430, the destination sector number in the software of the device for the patch/upgrade and Data Size are found from the Data in the temporary storage sector and all data from that destination sector in the software is copied to the temporary memory. Specifically, lines 17F5 through 17F8 are copied from the sector in the device software and lines 2000 through 2004 are added to the device software.

Thus, the data section originally appearing in lines 17F5 through 17F8 is overwritten in Step 440 with the new Data from the temporary storage sector illustrated in FIGS. 8 and 9. To complete the upgrade/patch, the updated software is written into the flash memory for long use storage. This completed patch entry is erased from the temporary storage sector. At this point, the temporary storage sector is assumed to be empty and, therefore, the inquiry in Step 450 is negative and the device is returned to its working mode in step 470.

When patches/upgrades are being propagated along branches of a network having a spanning-tree structure, the executions of the upgrade/patch are orthogonal and, therefore, conducted in parallel.

In the embodiments of the method described above, nodes of a communications network are mentioned. FIG. 10 is a block circuit diagram of a node 1000 that can carry out the processes according to the invention, regardless of the nature of the network, but, preferably, for a spanning-tree network. Each node 1000 has a processor 1100 for processing communications, a receiver 1200 for receiving communications, and a transmitter 1300 for transmitting communications. Of course, the receiver 1200 and the transmitter 1300 can be combined into a non-illustrated transceiver unit 1200/1300. Each node can also have a memory 1400. The memory 1400 is not limited to holding the data mentioned herein and can be used for any needed storage operation of the processor 1100. The node 1000 is, therefore, capable of sensing, processing, transmitting, receiving, and actuating within a given communications range.

While the preferred embodiments of the invention have been illustrated and described, it will be clear that the invention is not so limited. Numerous modifications, changes, variations, substitutions, and equivalents will occur to those skilled in the art without departing from the spirit and scope of the present invention as defined by the appended claims.

1. A method for secured software patching and upgrade in a distributed wireless sensor network, which comprises:
providing a spanning-tree network of communications nodes with at least one root, node and at least one software upgrade repository;
receiving a software upgrade with the root node;
communicating the upgrade from the root node to the software upgrade repository; and
installing the upgrade on the software upgrade repository by authenticating a patch key and delivering and installing the upgrade in the software upgrade repository after authentication occurs.

2. The method according to claim 1, which further comprises providing the communications nodes as sensor devices each sensing, processing, transmitting, receiving, and actuating in a given geographical area.

3. The method according to claim 1, which further comprises:
deploying and managing the patch key of the software upgrade repository with the root node; and
defining a length of the patch key with the root node.

4. The method according to claim 1, which further comprises:
carrying out subgroup controller functions with the software upgrade repository;
coordinating new patch key deployment with the software upgrade repository; and
managing all of the nodes underneath the software upgrade repository on the same branch of the spanning tree with the software upgrade repository.

5. The method according to claim 1, which further comprises varying a length of the patch key on at least one branch of the spanning-tree.

6. The method according to claim 1, which further comprises providing at least one root node of the network as a gateway to another network.

7. The method according to claim 1, which further comprises providing at least one root node of the network as a gateway to the Internet.

8. The method according to claim 1, which further comprises carrying out the installation of the upgrade in parallel on a plurality of software upgrade repositories.

9. The method according to claim 1, which further comprises carrying out the installation of the upgrade in parallel on a plurality of software upgrade repositories within the same upgrade session.

10. The method according to claim 1, which further comprises carrying out the installation of the upgrade in parallel on orthogonal branches of the network.

11. The method according to claim 1, which further comprises carrying out the installation of the upgrade in parallel on orthogonal branches of the network within the same upgrade session.

12. The method according to claim 11, which further comprises forming, with the nodes in the same session, a group with a unique group session key determined by the software upgrade repository.

13. The method according to claim 12, which further comprises starting the software upgrade installation from the software upgrade repository along a respective branch and repeating the software upgrade installation through the branch until all leaf nodes on the branch have the upgrade installed thereon.

14. The method according to claim 13, which further comprises generating a two-byte patch key with the Diffie-Hellman algorithm in every step along the branch on each node in the same session.

15. The method according to claim 14, which further comprises, before carrying out the upgrade, exchanging at least one of a key length, a session key, the patch key, and a prime modulus between the two nodes undertaking the upgrade.

16. The method according to claim 15, which further comprises:
maintaining the session key with the software upgrade repository; and
sharing the session key and the prime modulus with all of the nodes in the same session.

17. The method according to claim 1, which further comprises starting the software upgrade installation from the software upgrade repository along a respective branch and repeating the software upgrade installation through the branch until all leaf nodes on the branch have the upgrade installed thereon.

18. The method according to claim 1, which further comprises generating a two-byte patch key with the Diffie-Hellman algorithm on the node.

19. The method according to claim 1, which further comprises carrying out the authentication with variable-length patch keys having a given length for the software upgrade repository and a shorter length for nodes of the network farther away from the root node than the software upgrade repository.

20. The method according to claim 1, which further comprises carrying out the authentication with different length patch keys, a patch key having a given length for communications between the root node and the software upgrade repository and another patch key having a length shorter than the given length for communications between the software upgrade repository and nodes farther away from the root node than the at least one software upgrade repository.

21. The method according to claim 1, which further comprises carrying out the authentication with different length patch keys, a patch key having a given length for communications on an active branch and a length shorter than the given length for communications on an inactive branch.

22. The method according to claim 1, which further comprises:
defining the software upgrade repository to be immediate children of the root node; and
managing the software upgrade repository with the root node.

23. The method according to claim 1, which further comprises providing the network with one software upgrade repository for each branch.

24. The method according to claim 1, which further comprises carrying out the authentication with patch keys generated locally on each node according to the Diffie-Hellman algorithm.

25. The method according to claim 1, which further comprises sharing a respective patch key on software upgrade repositories on branches with orthogonal updating processes running in parallel.

26. The method according to claim 1, which further comprises:
storing the patch key in both the software upgrade repository and the node to be upgraded; and
determining, with the software upgrade repository, if the patch key received from the node is valid and if so, providing a session key to the node.

27. The method according to claim 16, which further comprises generating and exchanging the patch key and prime modulus by:
first, generating the patch key with the software upgrade repository utilizing the key length, a secret key, and a predefined prime modulus;
second, executing the Diffie-Heliman algorithm with the software upgrade repository to obtain the patch key;
third, sending at least the key length, the patch key, and the prime modulus, to the node to be upgraded;
fourth, picking a random secret number and executing the Diffie-Heilman algorithm with the node to be upgraded to generate a patch key of the node, and sending the patch key of the node to the software upgrade repository;
fifth, authenticating correct reception of the patch key of the node as a condition for the software upgrade repository to authenticate a session key back to the node;
sixth, executing the Diffie-Hellman algorithm with the software upgrade repository upon receiving the patch key of the node to generate a session key;
seventh, authenticating the node to proceed and start the upgrade installation on the node when the node receives the session key.

28. The method according to claim 27, which further comprises:
sending an invitation message with a software version number to the node; and
accepting the invitation with the node and sending an acknowledgement message back to the software upgrade repository containing at least one of the software version number of the node, the session key and a node identification.

29. The method according to claim 28, which further comprises repeating the authentication between the node and at least one subsequent node on the branch.

30. The method according to claim 28, which further comprises repeating the authentication between the node and at least one subsequent node on the branch until all nodes in the branch have executed the installation.

31. The method according to claim 28, which further comprises repeating the authentication between the node and at least one subsequent node on the branch until all nodes in orthogonal branches have executed the installation.

32. The method according to claim 31, which further comprises subsequently repeating the authentication between all nodes on other different orthogonal branches until all nodes have executed the installation, each of the different orthogonal branches having a different session key.

33. The method according to claim 1, which further comprises carrying out the upgrade installation by:
downloading at least one upgrade from an upgrade server and saving the upgrade on a device in the network to be upgraded including at least one of the root node, the software upgrade repository, and a node;
sending information regarding present characteristics of the device to be upgraded to the upgrade server and determining, with the upgrade server, if an upgrade needs to be performed for the device;
receiving, with the device to be upgraded, a response to the information sent from the upgrade server and parsing the response to determine what aspects of the device needs to be upgraded;
selecting an appropriate upgrade with the device to be upgraded, sending a request to the upgrade server to send the appropriate upgrade, and downloading relevant upgrade data; and
saving the upgrade data in the device at a temporary storage sector.

34. The method according to claim 33, which further comprises providing the upgrade server as any device in the network able to transfer the upgrade.

35. The method according to claim 33, which further comprises sending the information through packet data.

36. The method according to claim 35, which further comprises providing the packet data with at least one of the group consisting of a start address, a current block number, a data size, data relevant for the upgrade, a total block number, and a checksum

37. The method according to claim 36, which further comprises sending information including at least one of a serial number, a patch version, and a configuration version.

38. The method according to claim 33, carrying out the upgrade installation by:
switching a node in the network to an upgrade mode at a given time; and
switching the node to a working mode if the temporary storage sector is empty and, if the temporary storage sector is not empty:
determining from the upgrade data in the temporary storage sector a destination sector number in software of the device for the upgrade; and
writing the upgrade data from the temporary storage sector over a data section of the destination sector in the software of the device.

39. The method according to claim 38, which further comprises, if the temporary storage sector is not empty:
storing a portion of the software of the device in the destination sector in a temporary memory of the device;
writing the upgrade data stored in the temporary storage sector over the software portion; and
writing the upgraded software portion into long-term memory of the device.

40. The method according to claim 38, which further comprises carrying out the determination step by determining from the data in the temporary storage sector a destination sector number in the software of the node for the upgrade and the data size and copying all data from the destination sector in the software to temporary memory in the device.

41. The method according to claim 38, which further comprises erasing the upgrade data from the temporary storage sector.

42. The method according to claim 38, which further comprises determining, with the device, if there is another upgrade stored in the temporary storage sector, and:
if another upgrade is not present, switching the node to a working node; and
if another upgrade is present:
determining if the other upgrade has been installed in the device and:
if so, switching the node to a working node; and
if not, repeating the temporary storage sector examination step, the destination sector number determination step, the writing step, and the subsequent upgrade determination step until all upgrades are installed in the device.

43. The method according to claim 42, which further comprises continuously searching for a new upgrade different from a last patch entry already installed in the device.

44. The method according to claim 38, which further comprises switching a node in the network to an upgrade mode immediately after the device is turned on.

45. The method according to claim 38, which further comprises, if the temporary storage sector is not empty, retrieving a start address and a data size from the upgrade data in the temporary storage sector.

46. A method for secured software patching and upgrade in a distributed wireless sensor network, which comprises:
providing a spanning-tree network of communications nodes with at least one root node and at least one software upgrade repository;
receiving a software upgrade with the root node;
communicating the upgrade from the root node to the software upgrade repository;
carrying out the installation of the upgrade in parallel on orthogonal branches of the network within the same upgrade session and forming, with the nodes in the same session, a group with a unique group session key determined by the software upgrade repository and maintaining the session key with the software upgrade repository; and
installing the upgrade on the software upgrade repository by:
generating patch keys locally on each node according to the Diffie-Hellman algorithm;
exchanging at least one of a key length, a session key, a patch key, and a prime modulus between the two nodes undertaking the upgrade and sharing the session key and the prime modulus with all of the nodes in the same session;
authenticating a patch key and delivering and installing the upgrade in the software upgrade repository after authentication occurs; and
starting the software upgrade installation from the software upgrade repository along a respective branch and repeating the software upgrade installation through the branch until all leaf nodes on the branch have the upgrade installed thereon.

47. In a spanning-tree network of communications nodes, a communications node, comprising:
a receiver for receiving communications from other communications nodes in a communications range;
a transmitter for sending communications to other communications nodes in said communications range;
a memory storing at least ranging information and a unique identification for describing the node; and
a processor connected to said receiver, to said transmitter, and to said memory, said processor being programmed to:
receiving a software upgrade;
communicate the upgrade to another one of the communications nodes; and
install the upgrade by authenticating a patch key and delivering and installing the upgrade in the node after authentication occurs.

48. A microprocessor programmed to carry out the steps of the method of claim 1.

49. A microprocessor programmed to carry out the steps of the method of claim 46.
